(19) United States
(12) Patent Application Publication
(10) Pub. No.: US 2003/0144996 A1
(43) Pub. Date: Jul. 31, 2003

(54) Method and system for transporting and displaying search results and information hierarchies

(76) Inventor: Larry Richard Moore JR., Tucson, AZ (US)

Correspondence Address: WEISS & MOY PC, 4204 NORTH BROWN AVENUE, SCOTTSDALE, AZ, 85251, US

(21) Appl. No.: 10/058,850

(22) Filed: Jan. 28, 2002

(51) Int. Cl. G06F 7/00

(52) U.S. Cl. 707/3

(57) ABSTRACT

A method and system for transporting and displaying search results and information hierarchies provides a powerful tool for implementing Internet search engines, directory displays and interfaces to similar structures. Upon receiving a user request for an information access, binary search result information including quality of match information is downloaded from a server to the user site. The search information is then interpreted and a graphical output is generated. Interpretation at the client-side provides flexibility in presentation and active reorganization of the display. Graphical user interfaces use the local binary search data to provide user reorganization and inspection of the data. A user may navigate through a three-dimensional map organized by regions and categories, a two-dimensional map organized by match quality and/or an enhanced list display that provides local behavior to modify the information display based on the downloaded search data.

### BACKGROUND OF THE INVENTION

1. Field of the Invention

The present invention relates generally to computer systems and portable computing devices, and more specifically, to a method and system for generating, transporting and displaying search results within a computer system or network.

2. Background of the Invention

Information technology is a constantly growing segment of business today. Network systems and recently the Internet and World-Wide-Web (WWW) have found increasing prominence in governments and business as well as personal lives. Local data storage and networked data storage have both expanded, due to a constantly decreasing cost of data storage and a growing market for computer systems. The Internet and WWW provide an individual access to a large quantity of information and local storage may be similarly large, especially where optical data storage and libraries are involved.

As a result of the availability of information, search systems, including operating system-based finders and web search engines have evolved to locate and categorize the huge volume of available information. Operating systems on local platforms have expanded to include complex searchers that can locate files by description or content, and search engines and directories on the Internet have proliferated to provide a means to locate the information present within the multiplicity of networked computers.

In addition to search systems, file system directory displays within operating systems have evolved to include organizational models such as graphical directory trees and Internet and other network displays have also included graphical models such as the file folder displays used within many web browsers to display directory structures for use with file transfer protocol.

Generally, present-day Internet search engines use a list display to show a portion of the results of a search (one page at a time) and the results are ranked from top to bottom. Alternative schemes have been developed, but generally a user does not have control of search results once they have been downloaded to a browser, as the search server typically pushes an HTML file to the browser and the browser displays the file.

Search engines and directory viewers within operating systems have user interfaces that are closely tied to the directory structure hierarchy and do not adapt their display to user selection of categories. Directory viewers on the Internet resemble search engines, as they display only the results of a category or sub-category submission and do not adapt to user input. In addition, much information is not available to the search user within the typical search engine display. Relationships of search results within one category to search results within other categories or sub-categories are not visible and in general a modification of a search discards the prior screen information. Further, any relationship between the search results that are displayed at one time is typically not indicated (Although some search engines do list a number of unlisted matches from the same site).

Therefore, it would be desirable to provide a method and system for transporting and displaying search results and directory information that has both visual appeal, and provides flexible access to the portion of search results of interest to a computer user.

### SUMMARY OF THE INVENTION

The above objective of transporting and displaying search results and directory information is achieved in a method and system that download query result data including location information and match quality information and provide a graphical display of the location information in conformity with an interpretation of the query result data.

Graphical user interfaces for facilitating the generation of a display adapted to user input provide a graphical interface that visually cues information such as popularity, match quality and location relationships among the location information (e.g., web locations that are from the same website). Other graphical user interfaces use directory information to generate a visual hierarchical display showing categories and adapt a display of query results that adapts to user interaction with the hierarchical display.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting various network connections and computer systems in which embodiments of the invention may be practiced.

FIG. 2 is a block diagram depicting organization of computer programs implementing the methods of the present invention within the memories of the computer systems depicted in FIG. 1.

FIG. 3 is a flowchart depicting operation of a system as embodied in a method in accordance with an embodiment of the invention.

FIG. 4 is a pictorial diagram depicting graphical output of an Internet browser, including a graphical user interface in accordance with an embodiment of the invention.

FIG. 5 is a flowchart depicting operation of a system implementing the graphical user interface of FIG. 3.

FIG. 6 is a pictorial diagram depicting graphical output of an Internet browser, including a graphical display in accordance with an alternative embodiment of the invention.

FIG. 7 is a flowchart depicting operation of a system implementing the graphical user interface of FIG. 6.

FIG. 8 is a pictorial diagram depicting graphical output of an Internet browser, including a graphical display in accordance with an alternative embodiment of the invention.

FIG. 9 is a pictorial diagram depicting graphical output of an Internet browser, including a graphical display in accordance with an alternative embodiment of the invention.

### DETAILED DESCRIPTION OF THE PREFERRED EMBODIMENTS

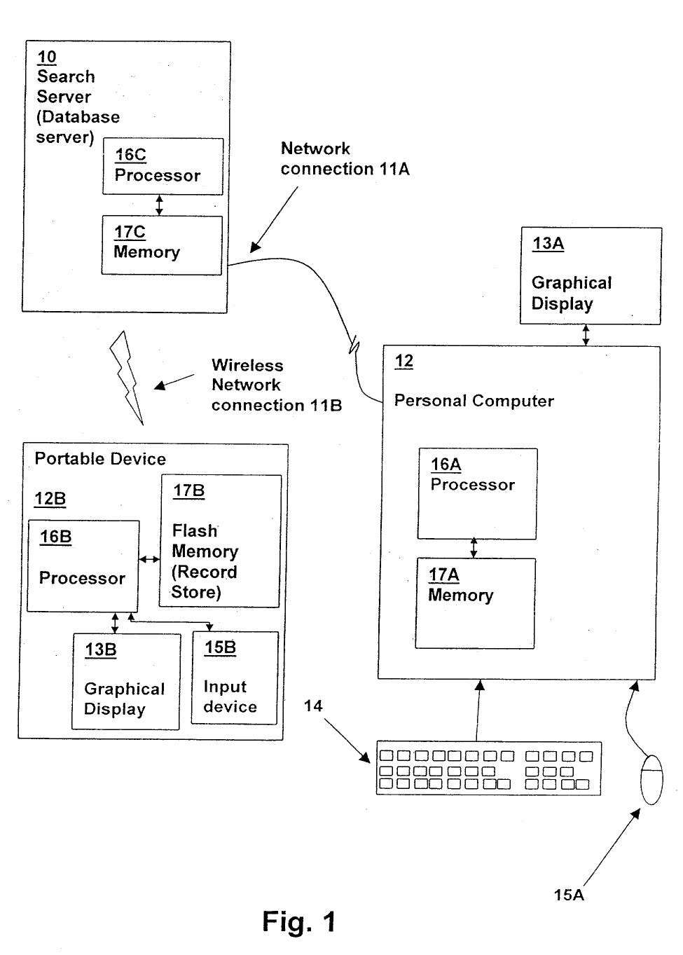

Referring now to the figures and in particular to FIG. 1, a networked computer system within which embodiments of the present invention are embodied is depicted in a block diagram. To support Internet search functions, a search server 10 is coupled to the Internet via a network connection 11A. Also coupled to the Internet is a personal computer 12 having a processor 16A coupled to a memory 17A for executing program instructions from memory 17A, wherein the program instructions include program instructions for executing a method in accordance with an embodiment of the present invention.

Personal computer 12 is coupled to a graphical display 13A for displaying program output such as the graphical user interfaces (GUIs) implementing embodiments of the present invention. Personal computer 12 is further coupled to input devices such as a mouse 15A and a keyboard 14 for receiving user input. The networked computer system may be coupled to a public network such as the Internet, or may be a private network such as the various “intra-nets” that are implemented within corporate offices and other installations requiring secure data communications.

Within memory 17A, a network browser program of the type in general use is executing and thereby providing access to the Internet via network connection 11A. For the illustrated embodiments, the network browser must be Java-enabled (that is, capable of providing execution of Java programs or “applets” associated with web pages, but the present invention also contemplates the implementation of the method and system thereof by providing dedicated program code within the browser itself or an associated “plug-in” software module.

Java code embodying a method in accordance with embodiments of the present invention is executed by processor 16A. Personal computer 12 is included to provide a demonstrative example of a general purpose computer, and it will be understood by those skilled in the art that the techniques of the present invention apply to a variety of other applications such as dedicated Internet appliances and large mainframe computers having user terminals. The present invention also applies to personal appliances such as personal digital assistants (PDAs) and Internet-enabled pagers and cellular telephones, although generally with the present state of the art in memory and display technologies and the resulting operating systems' limitations, an alternative embodiment of the present invention as described below will be preferred.

A second computing device, portable device 12B is shown coupled to search server 10 by a wireless network connection 11B. Portable device 12B may be a personal digital assistant (PDA) or another device adapted to provide a wireless and portable connection to the Internet (or other network), such as Internet-enabled cellular telephones, pagers, e-mail readers and the like. Portable device includes a processor 16B coupled to a flash memory (typically referred to as a “Record Store”) in which program instructions in accordance with an embodiment of the present invention are stored, whereby processor 16B executes program instructions implementing a method in accordance with an embodiment of the invention. Within the present description, where the terms Java object, Java applet, etc., are used to refer to the local program responsible for displaying and interpreting search results and directory information, it should be understood that the description also generally applies to the operation of the dedicated application provided for PDAs. The primary difference being the absence of a general-purpose browser to provide a framework for execution of Java code and that search server 10 will perform more of the computations for rendering the display in the PDA implementation in some embodiments of the invention.

Search server 10 also comprises a processor 16C and a memory 17C containing program instructions in accordance with embodiments of the present invention. For implementation in association with the traditional browser executing within personal computer 12, search server 10 provides download of the Java applet and provides search results to the Java applet, but implementations associated with a dedicated application executing within portable device 12, search server 10 may provide more interaction and memory 17C may contain code that provides some or all of the graphical calculations required to implement methods in accordance with some embodiments of the present invention.

The present invention also includes novel user interfaces that are applicable to search engines and directory viewers in general, and therefore Internet or any other network connection is not a requirement to practice the graphical presentation techniques of the present invention.

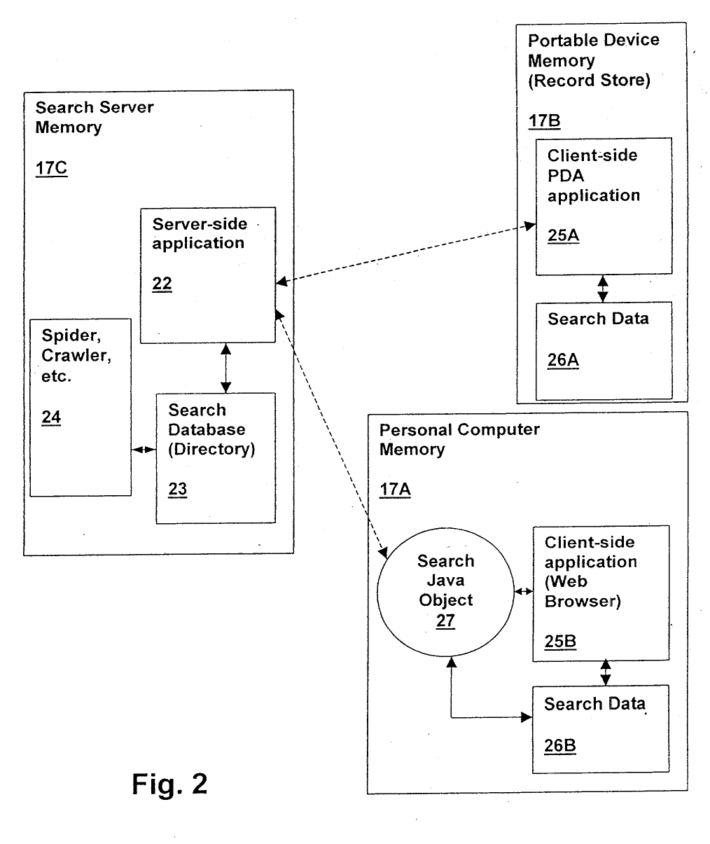

Referring now to FIG. 2, the organization of computer programs implementing methods of the present invention are depicted in a block diagram. Search server memory 17C contains a server-side application 22 that connects to a search Java object 27 executing from a client-side application, in this case a Web browser 25B. Search Java object 27 receives search data 26B from server-side application 22 executing from search server memory 17C.

In contrast to traditional search server operation, search server 10 does not push HTML pages to web browser 25B, but instead returns binary search data 26B containing search result information for each match comprising 1) web location information and 2) information about the location which may include: quality of the match (i.e., how closely the location associates with the search term), popularity of the site, and information from the location and other locations regarding the page (references from other sites, meta-tag information such as a description and title from the location, and other pertinent information about the site).

In some embodiments of the present invention, search Java object 27 provides interpretation of the search results in conformity with the location information and user input. In other embodiments, an associated category hierarchy is displayed (based upon additional category information downloaded to search Java object 27) and a display of search results is adjusted due to user interaction with the category display. In general, the downloaded search data 26B resident in memory 17A within the client-side local machine provides flexibility to the graphical user interface so that a more dynamic and powerful interface is supplied to a user.

Search data supplied to search Java object 27 is downloaded in response to a request transmitted from search Java object 27 to a server-side application 22 resident in memory 17C within search server 10. Server-side application 22 accesses a search database (or directory) 23, retrieves the pertinent information regarding match locations, and transmits the retrieved information to search Java object 27. Search database 23 may be maintained by a search tool such as a spider, crawler or other application 24 (including human-assisted directory building), which may be resident within search server memory 17C, located remotely and may be provided by another service provider whereby a complete search database or directory is copied over search database 23 periodically.

Portable device 12B operation in accordance with embodiments of the present invention, is similar to the operation of personal computer 12. However, due to the limited memory available, a dedicated client-side PDA application 25A will generally be used, as portable device 12B may not implement a complete Java-enabled web browser and may not directly support the graphical functions required to implement the graphical user interfaces of the present invention.

Search data 26A that is downloaded to portable device memory 17B from server-side application 22 is binary data as in the above-described personal computer 12 operation, but due to the graphical limitations and other constraints, the downloaded data may contain pre-drawn portions of the graphical display output, or screen images useable to produce results similar to the graphical display output of personal computer 12. For example, search server 10 may create a binary image file for display on portable device display 13B, so that interpretation of the search results is partially performed at search server 10. User interaction is still provided by client-side PDA application 25A so that search server 10 will be polled for updated graphical binary data to adjust the display in conformity with user input and an interpretation of the search results, in order to achieve a graphical user interface in accordance with embodiments of the present invention as described below.

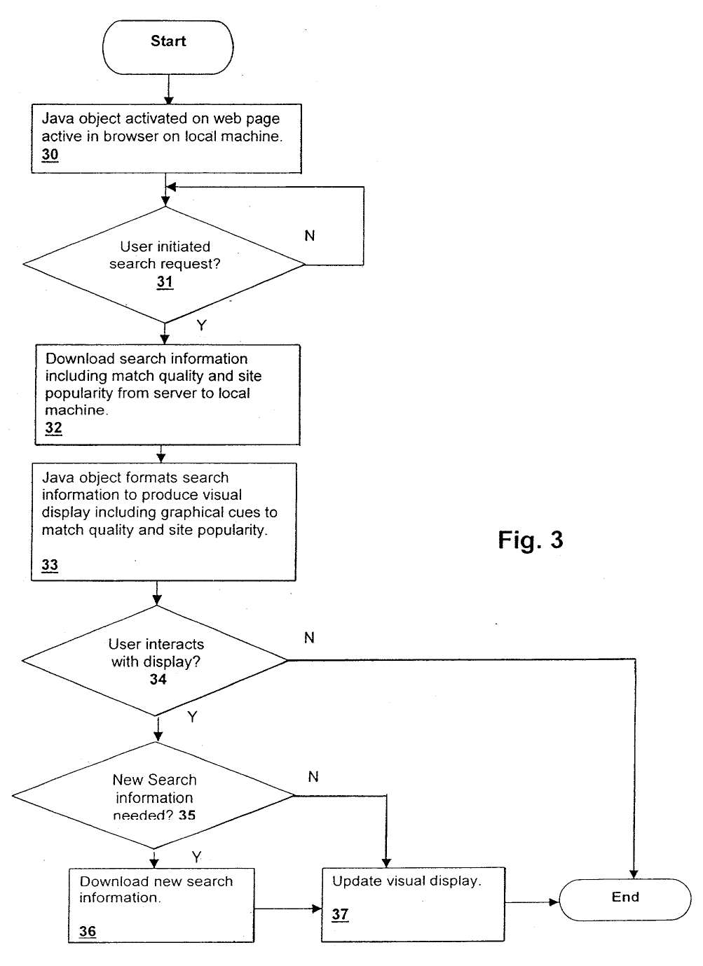

Referring now to FIG. 3 operation of the system of the present invention in accordance with a method of the present invention is depicted in a flowchart. First, a Java object (search server object 27) is activated on the web page active in browser 25B on local machine 12 (step 30). The Java object may be downloaded as a dynamic object, or in some cases may be preinstalled within a class library maintained on local machine 12. Next, if a user initiates a search request (decision 31), search information is downloaded to local machine 12 (step 32). The information is binary search result data containing location, match quality information and site popularity information for each location in the search result data. Java object 27 then formats the search result data to produce a visual display that includes graphical cues to match quality and site popularity (step 33). In some embodiments of the invention, the graphical cues are generally graphical figures that give an immediate picture of the search results. In other embodiments of the invention, the visual display is similar to the text lists of existing search engine HTML output, but the display is dynamic in the sense that user interaction may reformat the visual display without requesting an update from search server 10.

When the user interacts with display (decision 34) (using an input device such as mouse 15A), if no new search information is needed (decision 35), the visual display is updated (step 37) in conformity with the user input. If new search information is needed (decision 35) it is downloaded (step 36) and the visual display is then updated in conformity with the new downloaded information and the user input (step 37).

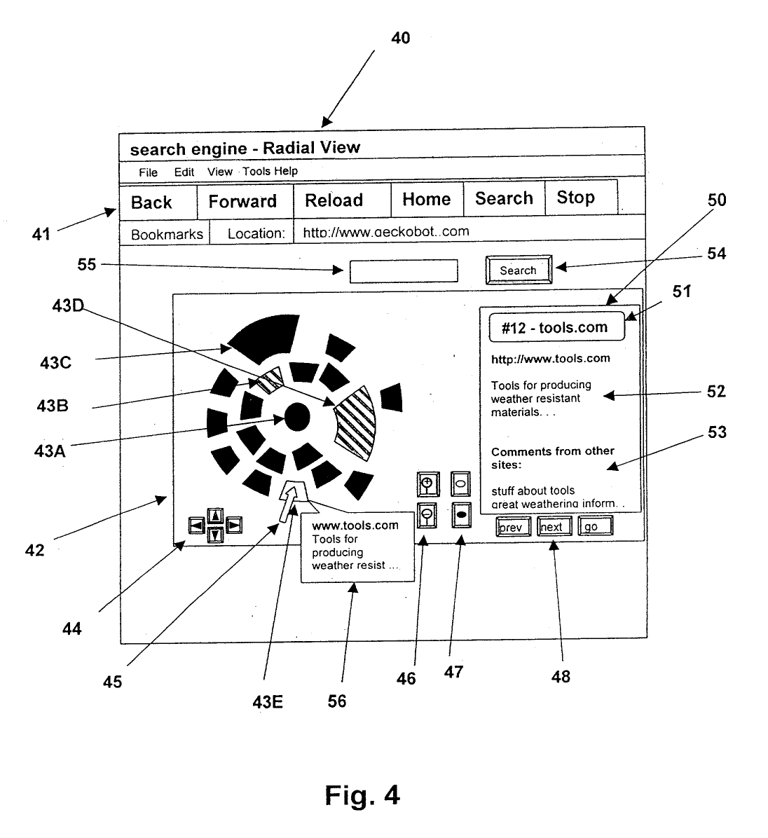

Referring now to FIG. 4, a graphical user interface in accordance with an embodiment of the invention is depicted. A browser graphical output 40 of a framework generally implemented in browsers currently installed on personal computers includes a toolbar and menu area 41 for interacting with the Internet and World-Wide-Web and for control of program features. A display area includes a graphical user interface 42 in accordance with an embodiment of the present invention that is implemented by search Java object 27.

A search term entry area 55 is provided along with a search button 54, to enable a user to enter a search query, which is then transmitted to search server 10. The search results are then passed to the local Java applet in binary form and interpreted to present a radial view interface 42 in accordance with an embodiment of the present invention.

Graphical FIGS. 43A, 43B, 43C, 43D and 43E are drawn in the radial view area. The position of graphical FIGS. 43A, 43B, 43C, 43D and 43E provide an indication of match quality by their radial position (i.e., distance from the center of the cluster). The size of graphical FIGS. 43A, 43B, 43C, 43D and 43E indicates the popularity of the locations associated therewith. For example, graphical FIG. 43C corresponds to a popular location having a match quality lower than the match quality of the location associated with graphical FIG. 43D, but similar popularity. The colors of graphical FIGS. 43A, 43B, 43C, 43D and 43E also provide an indication of 1) the active location (selected location) which is generally drawn in a bright color such as yellow. Central FIG. 43A indicates the best match and is initially set to be the active location. In the illustration, graphical pointer 45 has been moved to graphical FIG. 43E and graphical figure has been set to be the active location. When graphical pointer 45 is located over one of the graphical figures, a text pop-up 56 may be generated containing information about the location, providing the user with a means for quickly inspecting the content of locations as the user moves around the radial view.

Brightness of graphical FIGS. 43A, 43B, 43C, 43D and 43E within a particular color also provides match quality information, for example various shades of blue may indicate inactive sites with their relative brightness and radial indicating their match quality. Color mapping indicates the co-location relationship of locations, for example graphical FIG. 43B and graphical FIG. 43D are both drawn in a similar color (but potentially differing brightness) such as green, to indicate that they are located at the same web site.

Various tools are provided for interaction with graphical user interface 42. Buttons 46 permit a user to zoom in and out of the radial view (which may include hundreds of graphical figures). Navigation buttons 44 provide translation of the radial view center within graphical user interface 42, and brightness buttons 47 permit adjustment of the brightness of the display (facilitating distinction of the graphical figures' match quality based on brightness). A search item display area 50 provides a listing of the active location information such as title and match number 51, URL and description 52 (from the meta-tag information), as well as comments from other sites 53 that link to the URL of the active location. Tool buttons 48 associated with search item display area 50 provides a previous/next button pair for moving through the search results (as an alternative to selecting the graphical figures in the radial view area) and a “lgo” button that will active a browser window with the selected URL (or alternatively will move the current browser window 40 to the selected URL, whereby the user can use the browser toolbar 41 back button to return to the search engine results.

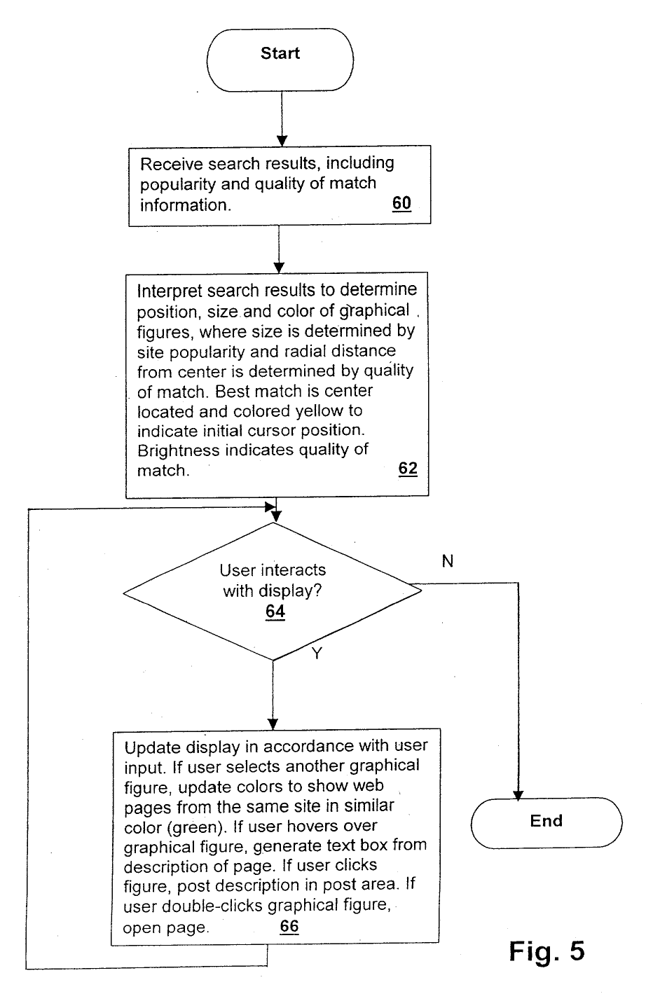

Referring now to FIG. 5, operation of a method for generating the radial view of FIG. 4 is depicted in accordance with an embodiment of the invention. First, search results are received from search server 10 in binary form, including popularity and quality of match information (step 60). Then, the local application interprets the search results to determine the position, size and color of the graphical figures (which may be circles and semi-circular arcs as depicted in FIG. 4, or an alternative graphical representation) (step 62). When a user interacts with the visual display (decision 64), the local application updates the display in conformity with the user input (step 66).

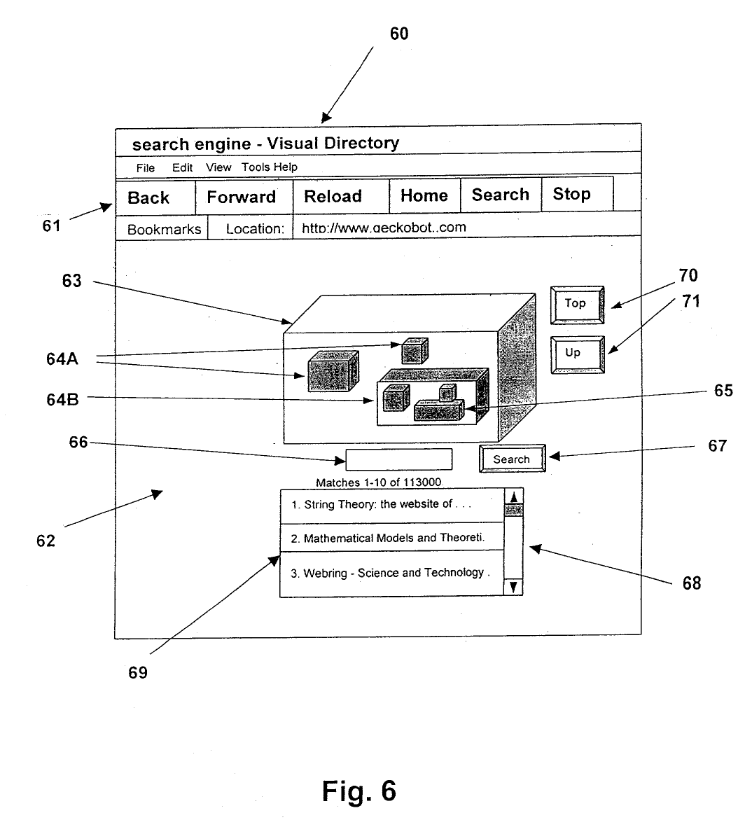

Referring now to FIG. 6, a graphical user interface in accordance with another embodiment of the invention is depicted. A browser graphical output 60 of a framework generally implemented in browsers currently installed on personal computers includes a toolbar and menu area 61 for interacting with the Internet and World-Wide-Web and for control of program features. A display area includes a graphical user interface 62 in accordance with an embodiment of the present invention that is implemented by search Java object 27.

A search term entry area 66 is provided along with a search button 67, to enable a user to enter a search query, which is then transmitted to search server 10. The search results are then passed to the local Java applet in binary form and interpreted to present a graphical user interface 62 in accordance with an embodiment of the present invention.

In the present embodiment, a hierarchical view 63 of a set of downloaded categories and subcategories is generated by the local Java applet. In the depicted illustration, the categories are represented by boxes contained within boxes, but other graphical figures such as spheres or circles may be used. The top-most box of hierarchical view 63 corresponds to the search universe, which is initially the entire directory structure or full search database. The user may select a category or subcategory in order to change the current search universe.

Along with hierarchical view 63, an associated search result display 69 is presented. In the depicted illustration, search result display is a list similar to those generally found in search engine displays, but in contrast to those displays, search result display 69 is generated in conformity with an interpretation of the current state of hierarchical view 63. Search result display 69 includes a scrollbar 68 for navigating the actual search results. By selecting a graphical object within hierarchical view 63, that object replaces the top-level box of hierarchical view 63, effectively “drilling in” to the category or sub-category (with a corresponding “zooming in” of the display). When a user “drills in” (by selecting a figure) or “drills out” (by using one of “up” button 71 or “top” button 70), search result display 69 is updated to include only the results within the selected category and sub-categories in conformity with the current state.

Category graphical FIGS. 64A are depicted as closed boxes and category graphical FIG. 64B is depicted as an open box. A box is opened by moving a graphical pointer over the box, and sub-category boxes such as sub-category boxes 65 may then be selected to replace the top level box with a new current selected box (selected state). It should be understood that the terms category and sub-category are only used to describe the relationship between adjacent levels and that further sub-category relationships may extend indefinitely in the hierarchical structure. The sizes of the boxes are determined by the number of URLs within each category or sub-category. The number of URLs determining size is a static number corresponding to the search database or directory count; the size of the boxes does not change with the search term. Categories and sub-categories might be geographical (such as continental categories with country sub-categories) or by industry, type of information, etc. The category types may be nested and combined so that, for example, the top-level categories and sub-categories select geographic locale and the lower-level sub-categories select type of industry or information or vice-versa. The above-described arrangement permits a user to get a quick view of the distribution and location of information.

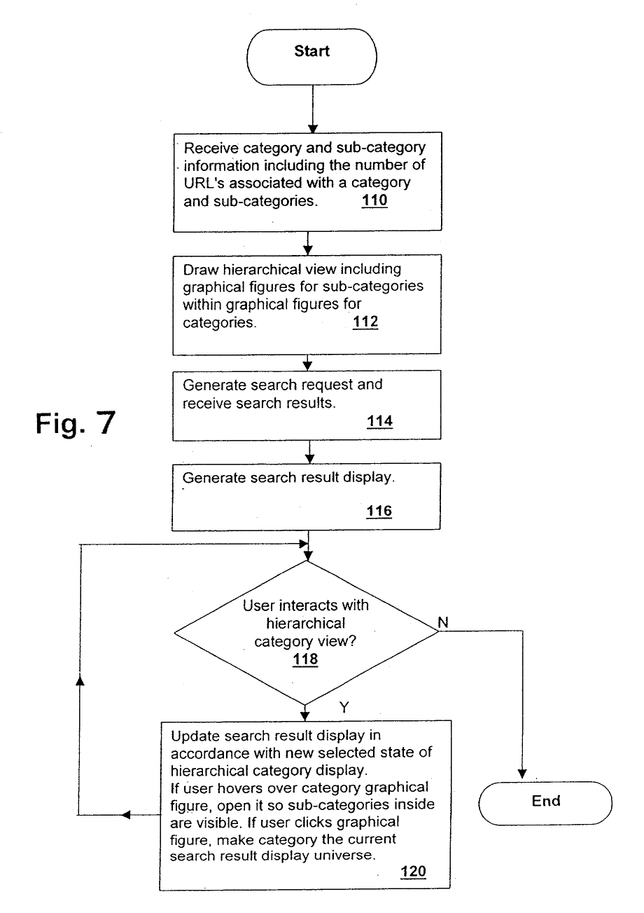

Referring now to FIG. 7, operation of a method for generating the hierarchical view of FIG. 6 is depicted in accordance with an embodiment of the invention. First, category and sub-category information are received in binary form including the number of URLs associated with each category and sub-category (step 110). Then, a hierarchical view is generated including graphical figures associated with categories and sub-categories (step 112). Next, a search request is generated and the results downloaded (step 114) and a search result display is generated (116). When a user interacts with the hierarchical display (decision 118) the search result display is updated with a new selected state of the hierarchical display (step 120).

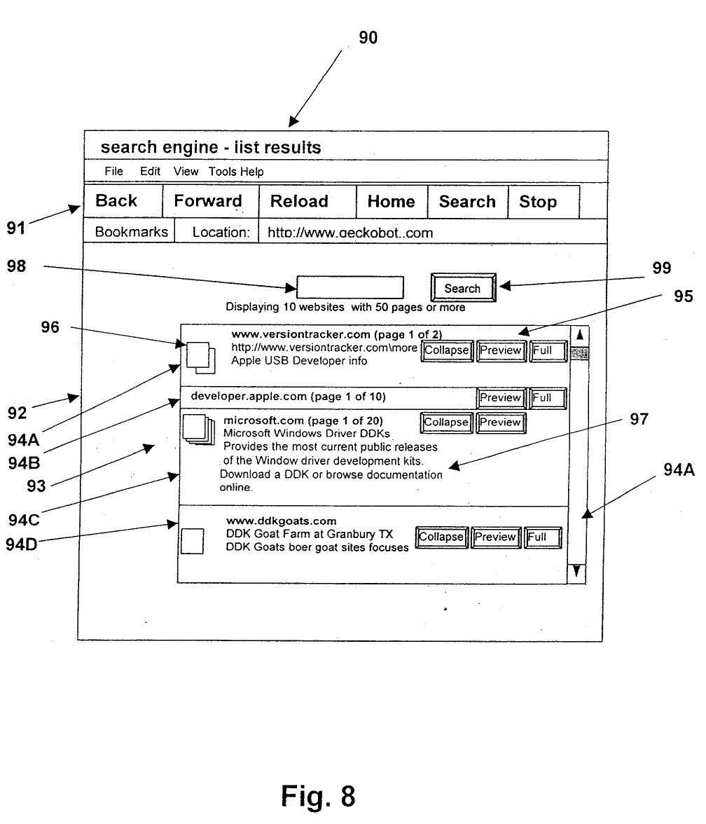

Referring now to FIG. 8, a graphical user interface in accordance with an alternative embodiment of the invention is depicted. A browser graphical output 90 of a framework generally implemented in browsers currently installed on personal computers includes a toolbar and menu area 91 for interacting with the Internet and World-Wide-Web and for control of program features. A display area includes a graphical user interface 92 in accordance with an embodiment of the present invention that is implemented by search Java object 27.

A search term entry area 98 is provided along with a search button 99, to enable a user to enter a search query, which is then transmitted to search server 10. The search results are then passed to the local Java applet in binary form and interpreted to present a graphical user interface 92 in accordance with an embodiment of the present invention.

In the present embodiment, a search result display 93 is presented. In the depicted illustration, search result display is a list similar to those generally found in search engine displays, but in contrast to those displays, search result display 93 includes selectable states for each list entry. A list entry may be collapsed to only occupy a single line of text or expanded to show the complete description of a location. Search result display 93 includes a scrollbar 100 for navigating the search result list. A set of buttons 95 located on each list entry permits selection of the state of the associated list entry. A list entry generally corresponds to a site or a single page. If a site with multiple pages is displayed (for example list entry 94A), a stack of page icons 96 permits selection of one of the pages by moving a graphical pointer over the page icons 96 to “thumb through” the pages.

The state selection and display variation is depicted by illustration. List entry 94A is in the “preview” state, which is the default state showing a medium amount of site/page information such as title, URL, number of pages and one line of the description. List entry 94B is shown in the “collapsed” state (selectable via a collapse button visible in other states of that entry), wherein only one line displays the number of pages and the title. List entry 94C is in the “full” state, where title, number of pages, URL and the full description are available (and optionally information from other sites—not shown). List entry 94D is an example of a single page entry in the default preview state.

The interface depicted in FIG. 8 provides a familiar presentation for search results, while dramatically increasing the flexibility of the interface over existing search engine displays. It should be noted that while an interface having an appearance like that of the interface of FIG. 8 could be implemented using HTML pushed pages, the download of binary search results and consequent local interpretation of search result data yields a very fast implementation of the interface that requires no additional download to change the visual state of the list entries.

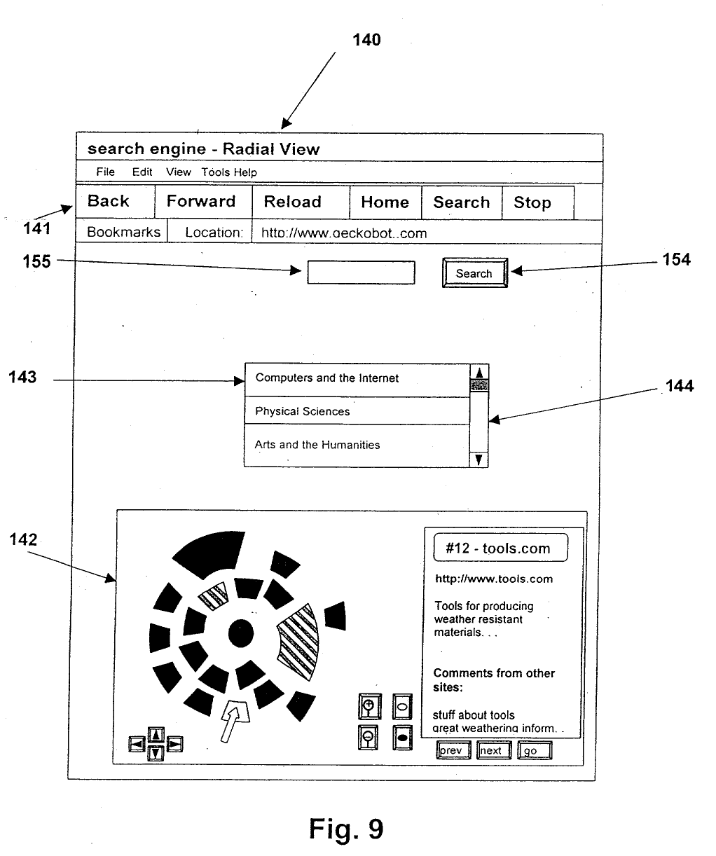

Referring now to FIG. 9, a graphical user interface in accordance with an alternative embodiment of the invention is depicted. The embodiment of FIG. 9 is an alternative embodiment that combines the features of the hierarchical view described above with the radial mosaic view (also described above).

A browser graphical output 140 of a framework generally implemented in browsers currently installed on personal computers includes a toolbar and menu area 141 for interacting with the Internet and World-Wide-Web and for control of program features. A display area includes both a radial view graphical user interface 142 in accordance with the above-described embodiment of the present invention, and a category list 143 in accordance with an alternative embodiment of the invention. Java object 27 may implement the combined interface, or multiple objects may be used to implement the combined interface.

A search term entry area 155 is provided along with a search button 154, to enable a user to enter a search query, which is then transmitted to search server 10. The search results are then passed to the local Java applet in binary form and interpreted to present a radial view interface 142 and Category information is used to generate category list 143 (with an associated scrollbar 144) in accordance with the present embodiment of the present invention.

Category list 143 operates in a manner similar to the above-described hierarchical view, and in an alternative embodiment, may be replaced by a graphical hierarchical view, but the present embodiment is chosen for the simplicity of the view presented to a user. Categories listed in category view 143 may be selected (for example, by double-clicking with a mouse). Selection of a category changes the selected state of the search hierarchy, and radial view will be generated (or regenerated) in accordance with the selected state, i.e., radial view 142 will display only the locations within the selected category. The resulting display is thus generated in conformity with entered search results (as described above for the radial view display of FIG. 4), but if a category is selected from category list 143, radial view 142 will be modified by the selected level in the hierarchy (category list) in a manner similar to that described for the hierarchical view of FIG. 6, i.e., radial view 142 will display the match locations found within the category or subcategory selected by category list 143. Selection of a category list 143 item may also cause the category list to change to a sub-category list for sub-categories within the selected category, permitting the searcher to “drill down” into the categories, with the radial view 142 updating to show the results within a selected category or sub-category. Alternatively, selection of a category list 143 item may cause another list or pop-up menu to be generated for selection of a sub-category.

All of the features of the radial view shown in FIG. 4 and described in the associated text may be applied within radial view 142 and all of the features of the hierarchical view depicted in FIG. 6 and described in the associated text may be integrated in place of category list 143 (except that search result display 69 of FIG. 6 is effectively replaced by radial view, enhancing the presentation of the search results to the user and the user's ability to examine the search results).

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for fulfilling a search request generated from a client computer to a search server, comprising:
instantiating a program on said client computer for requesting and presenting a result of said search request;
transmitting information specifying said search request to said search server;
downloading binary search result data from a database within said search server to said client computer, said search request result comprising location information and match quality information;
interpreting said location information and match quality information for display of said location information on a graphical display of said client computer, whereby said location information is formatted for presentation on said graphical display by said program; and
generating said graphical display in conformity a result of said interpreting.

2. The method of claim 1, wherein said instantiating instantiates a Java applet within a browser program executing within said client computer, and wherein said interpreting is performed by said Java applet on said binary search result data and wherein said Java applet generates a graphical display in conformity therewith.

3. The method of claim 1, wherein said client computer is a personal digital assistant (PDA), and wherein said instantiating executes a dedicated application within said PDA and wherein said interpreting is performed by said dedicated application on said binary search result data and wherein said dedicated application generates a graphical display in conformity with a result of said interpreting.

4. The method of claim 3, wherein said client computer is a personal digital assistant (PDA) and wherein said dedicated application further polls said search server for graphical information for generating said graphical display, wherein said interpreting is performed by said search server, said downloading downloads said graphical information along with said binary search result data, and wherein said dedicated application generates said graphical display in conformity with said downloaded graphical information and said binary search result data.

5. The method of claim 1, wherein said generating generates a list of said location information and a control interface at each list item for manipulating said list item, and further comprising:
receiving a user input at said control interface for manipulating said list item; and
in response to said receiving, modifying a display of said list item in conformity with said user input without generating another request to said search server.

6. The method of claim 5, wherein said list is a collapsible list, wherein each list item is representable by a verbose state and a sparse state, and wherein said modifying changes a state of said list item display in response to said receiving.

7. The method of claim 1, wherein said generating generates a graphical mosaic comprising graphical figures each corresponding to a location, and wherein characteristics of said graphical figures are adjusted in conformity with said interpretation of said match quality information.

8. The method of claim 7, wherein said generating further generates a category selection list, and wherein said graphical mosaic is generated from a set of locations corresponding to a selected category of said category selection list.

9. The method of claim 8, wherein said graphical mosaic comprises a radial view wherein a radial position each of said graphical figures increases with a decreasing match quality.

10. The method of claim 7, wherein said graphical mosaic comprises a radial view wherein a radial position each of said graphical figures increases with a decreasing match quality.

11. The method of claim 10, wherein a color of said graphical figures denotes locations that are located at the same site.

12. The method of claim 10, wherein a brightness of said graphical figures further denotes a quality of match of the corresponding location.

13. The method of claim 10, wherein a size of said graphical figures denotes a popularity of the corresponding location.

14. The method of claim 10, wherein said graphical figures comprise:
a central circular figure corresponding to a best match from said set of locations; and
a plurality of semi-circular arcs each corresponding to one of the remainder of said locations, each arc having a thickness and an angular length determined at said generating, said thickness and an angular length of said arc corresponding to a quality of match of said corresponding one of said location.

15. The method of claim 10, further comprising:
receiving a user selection of one of said graphical figures made by a user moving a graphical pointer over said one of said graphical figures; and
in response to said receiving, generating a text box containing a description of the corresponding location near said graphical figure.

16. The method of claim 1, wherein said generating generates a hierarchical view wherein graphical figures corresponding to a set of categories is generated on said graphical display, and wherein said interpretation is performed in conformity with a selected state of said hierarchical view, and wherein said generating generates a display of said location information in conformity with said selected state.

17. The method of claim 16, wherein said generating further generates a display of said location information in conformity with said match quality information.

18. The method of claim 16, wherein said generating generates a hierarchical view comprising graphical figures each corresponding to one of said set of categories, and wherein a user selects said selected state by selecting one of said category graphical figures.

19. The method of claim 18, wherein said generating generates a graphical display having graphical figures corresponding to sub-categories within said categories and wherein said hierarchical view comprises sub-category graphical figures each corresponding so one of said set of sub-categories drawn within said category graphical figures whereby said user may select a level of said selected state by selecting one of said sub-category graphical figures or one of said category graphical figures.

20. The method of claim 18, wherein said generating further generates a graphical mosaic comprising mosaic graphical figures each corresponding to a location, wherein characteristics of said mosaic graphical figures are adjusted in conformity with said interpretation of said match quality information, and wherein said mosaic graphical figures correspond to one of a set of locations determined in conformity with said selected state of said hierarchical view.

21. The method of claim 20, wherein said graphical mosaic comprises a radial view wherein a radial position each of said mosaic graphical figures increases with a decreasing match quality.

22. A graphical user interface method for displaying search results downloaded from a search server, said search results including a set of location information and match quality information, said method including:
generating a list of said location information and a control interface located at each list item for manipulating said list item on a graphical display;
receiving a user input at a particular control interface for manipulating an associated list item; and
in response to said receiving, modifying a display of said particular list item in conformity with said user input without generating another request to said search server.

23. The graphical user interface method of claim 22, wherein said list is a collapsible list, wherein display of each list item is representable by a verbose state and a sparse state, and wherein said modifying changes a state of said display of said list item in response to said receiving.

24. A graphical user interface method for displaying Internet search results downloaded from a search server, said search results including a set of location information and match quality information, said method including generating a graphical mosaic comprising graphical figures each corresponding to a location, and wherein characteristics of said graphical figures are generated in conformity with said interpretation of said match quality information.

25. The graphical user interface method of claim 24, wherein said graphical mosaic comprises a radial view wherein a radial position of said graphical figures increases with a decreasing match quality.

26. The graphical user interface method of claim 24, wherein a color of said graphical figures denotes locations that are located at the same site.

27. The graphical user interface method of claim 24, wherein a brightness of said graphical figures further denotes a quality of match of the corresponding location.

28. The graphical user interface method of claim 24, wherein a size of said graphical figures denotes a popularity of the corresponding location.

29. The graphical user interface method of claim 24, wherein said graphical figures comprise:
a central circular figure corresponding to a best match from said set of locations; and
a plurality of semi-circular arcs each corresponding to one of the remainder of said locations, each arc having a thickness and an angular length determined at said generating, said thickness and an angular length of said arc corresponding to a quality of match of said corresponding one of said locations.

30. The graphical user interface method of claim 24, further comprising:
receiving a user selection of one of said graphical figures made by a user moving a graphical pointer over said one of said graphical figures; and
in response to said receiving, generating a text box containing a description of the location corresponding to said graphical figure.

31. The graphical user interface method of claim 24, further comprising generating a category selection list, and wherein said graphical mosaic is generated from a set of locations corresponding to a selected category of said category selection list.

32. The graphical user interface method of claim 24, further comprising generating a hierarchical view wherein graphical figures corresponding to a set of categories is generated within a graphical display, and wherein said hierarchical view is adapted for user input for selecting a state of said hierarchical view, and wherein said graphical mosaic is generated from a set of locations corresponding to a selected state of said hierarchical view.

33. A graphical user interface method comprising:
generating a hierarchical view wherein graphical figures corresponding to a set of categories is generated within a first area of a graphical display, and wherein said hierarchical view is adapted for user input for selecting a state of said hierarchical view;
interpreting a set of search results in conformity with a selected state of said hierarchical view; and
generating a search result display from said interpreted search results in a second area of said graphical display.

34. The graphical user interface method of claim 33, wherein said generating generates a hierarchical view comprising category graphical figures each corresponding to one of said set of categories, and wherein a user selects said selected state by selecting one of said category graphical figures.

35. The graphical user interface method of claim 33, wherein said generating generates a graphical display having graphical elements corresponding to sub-categories within said categories and wherein said hierarchical view comprises sub-category graphical figures drawn within said category graphical figures, each corresponding to one of said set of sub-categories whereby said user may select a level of said selected state by selecting one of said sub-category graphical figures or one of said category graphical figures.

36. A computer network comprising:
a search server for providing search database information in response to search requests;
a client computer system coupled to said search server via said network, said computer system comprising a memory for storing program instructions and data coupled to a processor for executing said program instructions, and wherein said program instructions comprise:
program instructions for requesting and presenting a result of said search request;
transmitting information specifying said search request to said search server;
downloading binary search result data from said search server, said search request result comprising location information and match quality information;
interpreting said location information and match quality information for display of said location information on a graphical display of said client computer, whereby said location information is formatted for presentation on said graphical display by said program; and
generating said graphical display in conformity a result of said interpreting.

37. The computer network of claim 36, wherein said program instructions are embodied in a Java applet for execution within a browser program executing within said client computer, and wherein said interpreting is performed by said Java applet on said binary search result data and wherein said Java applet generates a graphical display in conformity therewith.

38. The computer network of claim 36, wherein said client computer is a personal digital assistant (PDA), and wherein said program instructions comprise a dedicated application executing within said PDA and wherein said interpreting is performed by said dedicated application on said binary search result data and wherein said dedicated application generates a graphical display in conformity with a result of said interpreting.

39. The computer network of claim 36 wherein said client computer is a personal digital assistant (PDA), further comprising server program instructions within a memory of said search server for execution by a processor within said search server, and wherein said program instructions within said client computer comprise a dedicated application executing within said PDA and wherein said interpreting is performed by said dedicated application on said binary search result data and wherein said dedicated application generates requests to said search server to provide data for generating a graphical display in conformity with a result of said interpreting and wherein said server program instructions supply graphical information in response to said requests.

40. A computer system comprising a memory for storing program instructions and data, a processor coupled to said memory for executing said program instructions, a graphical display device coupled to said processor for displaying a graphical user interface (GUI) and an input device coupled to said processor for providing user input, wherein said program instructions comprise program instructions for:
receiving search results including a set of location information and match quality information, and
generating a graphical mosaic comprising graphical figures each corresponding to a location, and wherein characteristics of said graphical figures are generated in conformity with said interpretation of said match quality information.

41. The computer system of claim 40, wherein said program instructions generate a graphical mosaic comprising a radial view wherein a radial position of said graphical figures increases with a decreasing match quality.

42. The computer system of claim 41, wherein said program instructions set a color of said graphical figures denoting locations that are located at the same site.

43. The computer system of claim 41, wherein said program instructions set a brightness of said graphical figures further denoting a quality of match of the corresponding location.

44. The computer system of claim 41, wherein said program instructions set a size of said graphical figures denoting a popularity of the corresponding location.

45. The computer system of claim 41, wherein said program instructions generate a graphical mosaic comprising a central circular figure corresponding to a best match from said set of locations, and a plurality of semi-circular arcs each corresponding to one of the remainder of said locations, each arc having a thickness and an angular length determined at said generating, said thickness and an angular length of said arc corresponding to a quality of match of said corresponding one of said locations.

46. The computer system of claim 40, wherein said program instructions further comprise program instructions for:
receiving a user selection of one of said graphical figures made by a user moving a graphical pointer over said one of said graphical figures; and
in response to said receiving, generating a text box containing a description of the location corresponding to said graphical figure.

47. The computer system of claim 40, wherein said program instructions further comprise program instructions for:
generating a list of categories; and
determining that a user has selected a category, and wherein said graphical mosaic is generated from a set of locations corresponding to said selected category.

48. A computer system comprising a memory for storing program instructions and data, a processor coupled to said memory for executing said program instructions, a graphical display device coupled to said processor for displaying a graphical user interface (GUI) and an input device coupled to said processor for providing user input, wherein said program instructions comprise program instructions for:
receiving search results including a set of location information;
generating a hierarchical view wherein graphical figures corresponding to a set of categories is generated within a first area of a graphical display, and wherein said hierarchical view is adapted for user input for selecting a state of said hierarchical view;
interpreting a set of search results in conformity with a selected state of said hierarchical view; and
generating a search result display from said interpreted search results in a second area of said graphical display.

49. The computer system of claim 48 wherein said program instructions for generating generate a hierarchical view comprising category graphical figures each corresponding to one of said set of categories, and wherein a user selects said selected state by selecting one of said category graphical figures.

50. The computer system of claim 49, wherein said program instructions for generating generate a graphical display having graphical elements corresponding to sub-categories within said categories and wherein said hierarchical view comprises sub-category graphical figures drawn within said category graphical figures, each corresponding to one of said set of sub-categories whereby said user may select a level of said selected state by selecting one of said sub-category graphical figures or one of said category graphical figures.

51. The computer system of claim 48, wherein said program instructions for receiving further receive match quality information corresponding to locations within said location information, and wherein said program instructions for generating further generate a graphical mosaic comprising graphical figures each corresponding to a location, and wherein characteristics of said graphical figures are generated in conformity with said interpretation of said match quality information, and wherein said graphical figures are generated from a set of locations corresponding to a selected state of said hierarchical view.

52. A computer program product comprising signal-bearing media encoding program instructions for execution within a general-purpose computer coupled to a search server via a network, wherein said program instructions comprise program instructions for:
instantiating a program for requesting a search and presenting a result of said search request;
transmitting information specifying said search request to said search server;
downloading binary search result data from said search server, said search request result comprising location information and match quality information;
interpreting said location information and match quality information for display of said location information on a graphical display of said computer, whereby said location information is formatted for presentation on said graphical display by said program; and
generating said graphical display in conformity with a result of said interpreting.

53. The computer program product of claim 52, wherein said program comprises a Java applet for execution within a browser program executing within said computer, and wherein said interpreting is performed by said Java applet on said binary search result data and wherein said Java applet generates a graphical display in conformity therewith.

54. The computer program product of claim 52, wherein said computer is a personal digital assistant (PDA), and wherein said program instructions comprise a dedicated application executing within said PDA and wherein said interpreting is performed by said dedicated application on said binary search result data and wherein said dedicated application generates a graphical display in conformity with a result of said interpreting.

55. A computer program product comprising signal-bearing media encoding program instructions for execution within a computer system, wherein said program instructions comprise program instructions for:
receiving search results including a set of location information and match quality information, and
generating a graphical mosaic comprising graphical figures each corresponding to a location, and wherein characteristics of said graphical figures are generated in conformity with said interpretation of said match quality information.

56. The computer program product of claim 55, wherein said program instructions for generating generate a graphical mosaic comprising a radial view wherein a radial position of said graphical figures increases with a decreasing match quality.

57. The computer program product of claim 56, wherein said program instructions set a color of said graphical figures denoting locations that are located at the same site.

58. The computer program product of claim 56, wherein said program instructions set a brightness of said graphical figures further denoting a quality of match of the corresponding location.

59. The computer program product of claim 56, wherein said program instructions set a size of said graphical figures denoting a popularity of the corresponding location.

60. The computer program product of claim 56, wherein said program instructions generate a graphical mosaic comprising a central circular figure corresponding to a best match from said set of locations, and a plurality of semi-circular arcs each corresponding to one of the remainder of said locations, each arc having a thickness and an angular length determined at said generating, said thickness and an angular length of said arc corresponding to a quality of match of said corresponding one of said locations.

61. The computer program product of claim 56 wherein said program instructions further comprise program instructions for:
receiving a user selection of one of said graphical figures made by a user moving a graphical pointer over said one of said graphical figures; and
in response to said receiving, generating a text box containing a description of the location corresponding to said graphical figure.

62. The computer program product of claim 56, wherein said program instructions further comprise program instructions for:
generating a list of categories; and
determining that a user has selected a category, and wherein said graphical mosaic is generated from a set of locations corresponding to said selected category.

63. A computer program product comprising signal-bearing media encoding program instructions for execution within a general-purpose computer system, wherein said program instructions comprise program instructions for:
receiving search results including a set of location information;
generating a hierarchical view wherein graphical figures corresponding to a set of categories is generated within a first area of a graphical display, and wherein said hierarchical view is adapted for user input for selecting a state of said hierarchical view;
interpreting a set of search results in conformity with a selected state of said hierarchical view; and
generating a search result display from said interpreted search results in a second area of said graphical display.

64. The computer program product of claim 63, wherein said program instructions for generating generate a hierarchical view comprising category graphical figures each corresponding to one of said set of categories, and wherein a user selects said selected state by selecting one of said category graphical figures.

65. The computer program product of claim 64, wherein said program instructions for generating generate a graphical display having graphical elements corresponding to sub-categories within said categories and wherein said hierarchical view comprises sub-category graphical figures drawn within said category graphical figures, each corresponding to one of said set of sub-categories whereby said user may select a level of said selected state by selecting one of said sub-category graphical figures or one of said category graphical figures.

66. The computer system of claim 63, wherein said program instructions for receiving further receive match quality information corresponding to locations within said location information, and wherein said program instructions for generating further generate a graphical mosaic comprising graphical figures each corresponding to a location, and wherein characteristics of said graphical figures are generated in conformity with said interpretation of said match quality information, and wherein said graphical figures are generated from a set of locations corresponding to a selected state of said hierarchical view.
